(19) United States
(12) Patent Application Publication
(10) Pub. No.: US 2007/0274865 A1
(43) Pub. Date: Nov. 29, 2007

(54) Erythrocyte sedimentation rate (ESR) test measurement instrument of unitary design and method of using the same

(76) Inventor: Denis A. Bouboulis, Greenwich, CT (US)

Correspondence Address: Thomas J. Perkowski, Esq., PC;Soundview Plaza, 1266 East Main Street, Stamford, CT, 06902, US

(21) Appl. No.: 11/653,761

(22) Filed: Jan. 16, 2007

Related U.S. Application Data
(63) Continuation-in-part of application No. 11/332,776, filed on Jan. 13, 2006.
Application No. 11/332,776 is a continuation-in-part of application No. 11/194,056, filed on Jul. 29, 2005.
Application No. 11/194,056 is a continuation of application No. 10/395,860, filed on Mar. 21, 2003, now Pat. No. 6,974,701.

(51) Int. Cl. G01N 15/05

(52) U.S. Cl. 422/73

(57) ABSTRACT

A disposable erythrocyte sedimentation rate (ESR) measurement instrument comprising a sedimentation measurement tube having a plunger portion, a blood collection tube having an upper portion, and an integrated locking mechanism provided between the blood collection tube and the sedimentation measurement tube. The locking mechanism permits the blood collection tube to be plunged into the blood collection tube upon rotating the sedimentation tube and the blood collection tube relative to each other, and thereafter pushing the sedimentation measurement tube into the blood collection tube. In a pre-evacuated embodiment of the present invention, the blood collection is pre-evacuated to withdraw a predetermined amount of blood during blood collection operations. In non-evacuated embodiment of the present invention, the plunger portion of the sedimentation measurement tube is inserted within the upper portion of the blood collection tube, at the time of assembly and manufacture, and is ready to be withdrawn by a predetermined about in order to manually evacuate the blood collection tube prior to use so that the blood collection tube is vacuum-pressurized to automatically draw a predetermined quantity of blood from a patient during blood collection operations.

### RELATED CASES

The Present application is a Continuation-in-Part (CIP) of copending application Ser. No. 11/332,776 filed Jan. 13, 2006; which is a Continuation-in-Part (CIP) of application Ser. No. 11/194,056 filed Jul. 29, 2005; which is a Continuation of application Ser. No. 10/395,860 filed on Mar. 21, 2003, now U.S. Pat. No. 6,974,701; each said application is commonly owned by Hemovations, LLC, and incorporated herein by reference as if set forth fully herein.

### BACKGROUND OF INVENTION

1. Field of Invention

The present invention relates to an improved method of, and a disposable test measurement instrument for, determining the Erythrocyte (or red blood cell) Sedimentation Rate (ERS) of a sample of anti-coagulated whole blood, in a safe, effective and inexpensive manner within diverse clinical settings.

2. Brief Description of the State of the Art

In 1894, Edmund Biemacki (1866-1912), a Polish physician, first noted the increased sedimentation rate of blood from ill individuals and realized that this increase was due to the presence of fibrinogen in the individual's blood sample.

In 1918, Robin Fahraeus (1888-1968) furthered Biernacki's work. His initial motivation to study the ESR of blood was as a pregnancy test, but his interest expanded to the study of the ESR test in disease states of his patients.

In 1921, Alf Westergren (1881-1968) refined the technique of performing the ESR test and reported its usefulness in determining the prognosis of patients with tuberculosis.

In 1935, Maxwell M. Wintrobe (1901-1986) published a variation of the ESR methodology and, at one time, this method was in wide use.

In 1977, the International Committee for Standardization in Hematology (ICSH) recommended the adoption of the Westergren method as the worldwide standard of ESR testing.

In 1997, the NCCLS published the ICSH's most recent recommendations on ESR Testing in the NCCLS Publication No. H2-A4 entitled “Reference and Selected Procedure For The Erythrocyte Sedimentation Rate (ESR) Test; Approved Standard (Fourth Edition), incorporated herein by reference in its entirety. Also, NCCLS has recently published a number of other important documents setting forth standards and guidelines in relation to ESR testing, namely: No. C28-A2 entitled “How to Define and Determine Reference Intervals in the Clinical Laboratory” which sets forth standard guidelines for determining reference values and reference intervals for quantitative clinical laboratory tests; No. H1-A4 entitled “Evacuated Tubes and Additives for Blood Specimen Collection” which sets forth standard requirements for blood collection tubes and additives including heparin, EDTA, and sodium citrate; No. H3-A4 entitled “Procedures for the Collection of Diagnostic Blood Specimens by Venipuncture” which sets forth standard procedures for the collection of diagnostic specimens by venipuncture, including line draws, blood culture collection, and venipuncture in children, and also includes recommendations on order of draw; No. H7-A3 entitled “Procedure for Determining Packed Cell Volume by the Microhematocrit Method” which sets forth the standard microhematocrit method for determining packed-cell volume, and addresses recommended materials and potential sources of error; No. H18-A2 entitled “Procedures for the Handling and Processing of Blood Specimens” which addresses the multiple factors associated with handling and processing specimens, as well as factors that can introduce imprecision or systematic bias into results; and also No. M29-A entitled “Protection of Laboratory Workers from Instrument Biohazards and Infectious Disease Transmitted by Blood, Body Fluids and Tissue” which sets forth guidance on the risk of transmission of hepatitis viruses and human immunodeficiency viruses in any laboratory setting, specific precautions for preventing the laboratory transmission of blood-borne infection from laboratory instruments and materials, and recommendations for the management of blood-borne exposure. Each of these NCCLS documents helps to indicate the state of knowledge in the art in this field, and is incorporated herein by reference in its entirety.

Today, the Erythrocyte Sedimentation Rate (ESR or Sed Rate) test is one of the most widely performed laboratory tests throughout the world, used to help screen for general illness by determining if a patient has a condition which is causing acute or chronic inflammation, indicated by elevated levels of fibrinogen in the patent's blood. While the ESR test is non-specific, it is still very helpful in following the course of some inflammatory diseases.

The Westergren ESR test method, which is the “Gold Standard” reference method for the ESR test, is performed by placing a diluted sample of anti-coagulated blood in a tall, perfectly vertical tube of 2.5 mm diameter and 200 mm length, and measuring how far in [mm/hr] the blood plasma/erythrocyte cell (P/E) interface level has settled under the influence of gravitational forces after the lapse of sixty (60) minutes (i.e one hour). The collected whole blood sample is prevented from coagulation by the addition of K3EDTA, and the anti-coagulated blood sample is then diluted by adding four parts of whole anti-coagulated blood to one part dilutent (such as physiologic saline or trisodium citrate at a concentration of between 0.10 to 0.136 mol/litre). The test works because the proteins associated with inflammation, particularly fibrinogen, counteract the zeta potential of red blood cells, which is created by a negative surface charge on the erythrocytes. This negative charge on the erythrocytes serves to repel the individual erythrocytes from each other and thus prolong erythrocyte sedimentation. When systemic inflammation is present, the fibrinogen content of the blood increases, and the erythrocytes tend to aggregate, thereby decreasing their surface-to-mass ratio, and thus increasing their rate of sedimentation.

The Wintrobe ESR test method employs a shorter tube (100 mm) than that used in the Westergren ESR method, and also a different anti-coagulant (i.e. ammonium oxide and potassium oxalate) in smaller amounts so as to not function as a diluting agent. It is generally accepted that the Wintrobe method is more sensitive for mild elevations, but also has a higher false positive rate than the Westergren method. On the other hand, the Westergren method is more sensitive for changes at the elevated levels and more useful where the ESR test is being used to evaluate the response to therapy, i.e. in diseases such as temporal arthritis.

Various types of prior art apparatus have been proposed for performing the ESR test using manual principles of operation. The following Patents describe such form of apparatus: U.S. Pat. No. 5,914,272; U.S. Pat. No. 5,779,983; U.S. Pat. No. 5,745,227; U.S. Pat. No. 5,244,637; U.S. Pat. No. 5,065,768; U.S. Pat. No. 4,701,305; U.S. Pat. No. 4,622,847; U.S. Pat. No. 4,434,802; U.S. Pat. No. 4,353,246; U.S. Pat. No. 4,187,719; U.S. Pat. No. 3,938,370; U.S. Pat. No. 3,910,103; U.S. Pat. No. 3,660,037; U.S. Pat. No. 3,373,601; UK Application No. GB 2 116 319 A; and UK Application No. GB 2 048 836 A, each patent being incorporated herein by reference.

However, the ESR test instrumentation disclosed in the above prior art references generally involves the handling of blood in a less than satisfactory manner, creates unnecessary risks to those performing the measurements and to those disposing of the collected blood samples, and requires the lab technician to possess a relatively high degree of skill and dexterity if the test results are to be measured accurately.

Various approaches to automating the ESR test have been attempted, notably using electronic and optical means for tracking the sedimentation of the erythrocytes and providing a result in less than the usual sixty minutes. Such techniques are illustrated in U.S. Pat. Nos.: No. 5,914,272; No. 5,575,977; No. 5,316,729; No. 4,801,428; No. 4,744,056; No. 4,187,462; and No. 4,041,502, each being incorporated herein by reference.

While these prior art methods and apparatus have reduced ESR test times substantially below the standard 60 minute test time period, the results produced by such prior art methods and apparatus do not correlate well with the “reference” Westergren ESR method, and involve the use of expensive equipment.

In Applicants' recent WIPO International Patent Publication No. WO 2004/085994, and U.S. Pat. No. 6,974,701, incorporate herein by reference, a new kind of ESR test instrument is disclosed, in which an air/fluid sealed sedimentation measurement tube containing a blood diluting agent (i.e. dilutent) is coupled to a vacuum-sealed blood collection tube containing an anti-coagulating agent (i.e. anti-coagulant), so that such sealed tubes are fixed relative to each other as a unitary assembly, prior to use. When the ESR measurement instrument is arranged in its blood collection configuration, a Leur® type connector is then connected to the vacuum-sealed blood collection tube and a sample of whole blood from a patient is drawn and injected into the blood collection tube of the ESR measurement instrument. Then after the sample of anti-coagulated blood has been collected in the sealed blood collection container and the Leur® type connector is disconnected therefrom, the air-seal of the sedimentation measurement tube is broken and then the sedimentation measurement tube is manually plunged into and to the bottom of the blood collection tube, using a single-handed operation, so as to rearrange the ESR measurement instrument into its ESR Measurement Configuration. This causes the liquid seal between the two tubes to be broken and the anti-coagulated sample of collected blood to mix with the physiologic NaCl solution contained in the sedimentation measurement tube, thereby filling up a substantial portion thereof with the diluted blood sample and permitting the blood plasma/erythrocyte cell (P/E) interface level of the diluted anti-coagulated blood sample to settle downwards toward the blood collection tube by a measurable distance during a predetermined test time period (e.g. 60 minutes) when the ESR measurement instrument is oriented in a gravity vertical position. Using this ESR measurement instrument, the ESR of the collected blood sample can be determined by measuring the distance that the P/E interface level travels against graduation markings on the sedimentation measurement tube, during the 60 minute test period.

While this highly innovative ESR test instrument design solves the shortcomings and drawback associated with prior ESR testing apparatus and methodologies, and offers numerous features and benefits, it would be highly desirable in particular circumstances, to enjoy portable and disposable products based on this general ESR test instrument design, with the added benefit of requiring fewer component parts and simpler manufacture, and also offering flexibility with regard to evacuation requirements of the blood collection tube at the time of product assembly and packaging.

Thus, there is a great need in the art for an improved method of and apparatus for measuring the rate of erythrocyte sedimentation in a sample of whole blood.

### OBJECTS AND SUMMARY OF THE PRESENT INVENTION

Accordingly, it is a primary object of the present invention to provide an improved method of and apparatus for measuring the Erythrocyte Sedimentation Rate (ESR) in a sample of whole blood.

Another object of the present invention to provide such apparatus in the form of an improved portable and disposable ESR test measurement instrument having a syringe-like form factor, and unitary construction.

Another object of the present invention is to provide such an ESR measurement instrument having a Blood Collection Configuration and an ESR measurement configuration.

Another object of the present invention is to provide such an ESR measurement instrument, wherein, during its Blood Collection Configuration, an air/fluid sealed sedimentation measurement tube containing a blood diluting agent (i.e. dilutent) is coupled to a vacuum-sealed blood collection tube containing an anti-coagulating agent (i.e. anti-coagulant), so that such sealed tubes are stationarily fixed relative to each other as a unitary assembly. While the ESR measurement instrument is arranged in its Blood Collection Configuration, a Leur® type connector is then connected to the vacuum-sealed blood collection tube and a sample of whole blood from a patient is drawn and injected into the blood collection tube of the ESR measurement instrument.

Another object of the present invention is to provide such an ESR measurement instrument, wherein after the sample of anti-coagulated blood has been collected in the sealed blood collection container and the Leur® type connector is disconnected therefrom, the air-seal of the sedimentation measurement tube is broken and then the sedimentation measurement tube is manually plunged into and to the bottom of the blood collection tube, using a single-handed operation, so as to rearrange the ESR measurement instrument into its ESR Measurement Configuration. This causes the liquid seal between the two tubes to be broken and the anti-coagulated sample of collected blood to mix with the physiologic (0.145 mol/L; 8.5 g/L; “0.85%) NaCl solution contained in the sedimentation measurement tube, thereby filling up a substantial portion thereof with the diluted blood sample and permitting the blood plasma/erythrocyte cell (P/E) interface level of the diluted anti-coagulated blood sample to settle downwards toward the blood collection tube by a measurable distance during a predetermined test time period (e.g. 60 minutes) when the ESR measurement instrument is oriented in a gravity vertical position. Using this ESR measurement instrument, the ESR of the collected blood sample can be determined by measuring the distance that the P/E interface level travels against graduation markings on the sedimentation measurement tube, during the 60 minute test period.

Another object of the present invention is to provide an improved portable and disposable ESR test instrument requiring fewer component parts and simpler manufacture, and also offering flexibility with regard to evacuation requirements of the blood collection tube at the time of product assembly and packaging.

Another object of the present invention is to provide a novel method of ESR measurement using an ESR measurement instrument having a unitary construction, with a syringe-like form factor.

Another object of the present invention is to provide such an ESR measurement method, wherein the needle of blood collecting apparatus is injected through a rubber cap associated with a blood collection tube that is vacuum-sealed and contains a predetermined quantity of anti-coagulant within the hollow interior volume of said blood collection tube and which is further integrated with a sedimentation measurement tube that is air/fluid-sealed and contains a predetermined quantity of blood sample diluting agent (e.g. physiologic NaCl solution or sodium citrate solution), wherein a liquid seal is disposed between the interior volume of said blood collection tube and the interior volume of said sedimentation measurement tube.

Another object of the present invention is to provide such an ESR measurement method, wherein a sample of whole blood is drawn from a patient's body under vacuum pressure and the blood sample collected through the needle and into the blood collection tube, wherein the collected sample of whole blood mixes with the predetermined quantity of anti-coagulant within the blood collection tube.

Another object of the present invention is to provide an improved erythrocyte sedimentation rate (ESR) measurement instrument having a syringe-like form factor, wherein an empty sedimentation measurement tube is coupled to a vacuum-sealed blood collection tube containing both an anti-coagulating agent (i.e. anti-coagulant) and a blood diluting agent (i.e. dilutent), so that such sealed tubes are stationarily fixed relative to each other as a unitary assembly during Blood Collection Operations, but are intercoupled into each other and arranged in fluid communication when the ESR measurement instrument is manually configured into its ESR Measurement Configuration.

Another object of the present invention is to provide an improved erythrocyte sedimentation rate (ESR) measurement instrument having a syringe-like form factor, wherein an empty sedimentation measurement tube is coupled to a vacuum-sealed blood collection tube containing only an anti-coagulating agent (i.e. anti-coagulant), so that such sealed tubes are stationarily fixed relative to each other as a unitary assembly during blood Collection operations, but are intercoupled into each other and are arranged in fluid communication when the ESR measurement instrument is manually configured into its ESR Measurement Configuration.

Another object of the present invention is to provide a portable and disposable ESR test measurement instrument which has several advantages, including the ability for its blood collection tube to be vacuum-sealed during assembly/manufacture, or alternatively, for air within the blood collection tube to be manually evacuated prior to blood drawing operations.

Another object of the present invention is to provide a portable and disposable ESR measurement instrument having a blood collection tube that contains a pre-measured quantity of anti-coagulant, and is vacuum sealed (i.e. vacuum-pressurized) during assembly to automatically draw a predetermined quantity of blood from a patient.

Another object of the present invention is to provide a portable and disposable ESR measurement instrument, wherein the plunger portion of its sedimentation measurement tube is inserted within the upper portion of the blood collection tube, ready to be withdrawn in order to manually evacuate the blood collection tube prior to use so that the blood collection tube is vacuum-pressurized to automatically draw a predetermined quantity of blood from a patient.

Another object of the present invention is to provide a portable and disposable ESR test measurement instrument, wherein its sedimentation tube and blood collection tube are provided with an integrated locking mechanism that prevents the sedimentation tube from being plunged into the blood collection container until the user rotates the tubes by 90 degrees.

Another object of the present invention is to provide a portable and disposable ESR test measurement instrument, wherein an integrated locking mechanism is provided between the blood collection tube and the sedimentation measurement tube so as to permit the blood collection tube to be plunged into the blood collection tube upon rotating the sedimentation tube and the blood collection tube relative to each other, and then pushing the sedimentation measurement tube into the blood collection tube.

Another object of the present invention is to provide such portable and disposable ESR test measurement instrument, wherein the integrated locking mechanism is realized by a pair of is lock flanges (i.e. projections) formed on the distal portion of the sedimentation measurement tube, and a corresponding pair of lock grooves (i.e. channels) formed in the top portion of the blood collection tube.

These and other objects of the present invention will become apparent hereinafter and in the Claims to Invention appended hereto.

### BRIEF DESCRIPTION OF THE DRAWINGS

FIG. 1 is an exploded view of the portable and disposable ESR measurement instrument of the preferred embodiment of the present invention, wherein the instrument can be assembled as follows, namely, the proximal end of the sedimentation tube is first passed through the blood collection tube with the lock flanges (i.e. projections) passed through corresponding lock grooves (i.e. channels) formed in the bottom flange and the top flange is screwed to the proximal end of the sedimentation tube, and then the air/fluid restriction plug is inserted therein, and thereafter the rubber plunger is filled with a small quantity of anti-coagulant (e.g. EDTA or citrate) and then the rubber plunger element is attached to the end of the sedimentation measurement tube, and finally the rubber cap is filled with premeasured quantity of anti-coagulant and is then attached to the distal end of the blood collection tube, preferably although not necessarily, under a vacuum condition during the assembly of the ESR measurement instrument;

FIG. 2A is a perspective view of the “prevacuated” embodiment of the portable and disposable ESR measurement instrument of the present invention shown disassembled in FIG. 1, wherein the blood collection tube contains a pre-measured quantity of anti-coagulant, and is vacuum sealed (i.e. vacuum-pressurized) during assembly to automatically draw a predetermined quantity of blood from a patient, according to the method of use and operation illustrated in FIG. 10;

FIG. 2B is a perspective view of the “non-prevacuated” embodiment of the portable and disposable ESR measurement instrument of the present invention shown in FIG. 1, wherein the plunger portion of the sedimentation measurement tube is inserted within the upper portion of the blood collection tube, ready to be withdrawn during manual evacuation of the blood collection tube, according to the method of use and operation illustrated in FIG. 11;

FIGS. 3B1 through 3B4, taken collectively, show perspective views of the ESR measurement instrument of the illustrative embodiment assembled without preevacuation of the blood collection tube, and illustrating the steps associated with the method of manually evacuating air from within the blood collection tube in accordance with the present invention, wherein the sedimentation measurement tube is rotated 90 degrees so that the locking flanges aligned with the locking channels and the sedimentation measurement tube can be pushed towards the bottom of the blood collection tube just above the anti-coagulent sample contained therein, and at this point, shown in FIG. 3A3, the rubber plunger is slowly withdrawn manually so that the lock flanges on the sedimentation measurement tube pass back through the lock grooves and the rubber plunger is moved to the top portion of the blood collection tube, at which point the sedimentation tube is then rotated 90 degrees so that the lock flanges lock with the bottom flange and the blood collection tube is evacuated to a pressure sufficient to draw a predetermined sample from a patient during subsequent blood drawing operations;

FIG. 4A is a perspective view of the ESR measurement instrument of the present invention (pre-evacuated as shown in FIG. 3A), shown arranged in its Blood Collection Configuration and about to be connected to a Vacutainer™ type connector for the drawing of a whole blood sample from a living human being, by venipuncture, in accordance with the method of the present invention;

FIG. 4B is a perspective view of the ESR measurement instrument of the illustrative embodiment shown in FIG. 2, with the Vacutainer™ connector shown connected to the blood collection tube of the ESR measurement instrument, the needle of the connector being pierced through its rubber cap, and a sample of whole blood being automatically drawn into the blood collection tube by virtue of the premeasured (i.e. predetermined or preestimated) vacuum provided within the sealed blood collection tube;

FIG. 4C is a partially-broken away, cross-sectional view of the blood collection tube of ESR measurement instrument of the illustrative embodiment shown in FIG. 2, with the Vacutainer™ connector shown connected to the blood collection tube of the ESR measurement instrument, the needle of the connector being pierced through its rubber cap, and a sample of whole blood being automatically drawn into the blood collection tube by virtue of the premeasured vacuum provided within the sealed blood collection tube;

FIG. 4D is a cross-sectional view of the ESR measurement instrument of the illustrative embodiment shown in FIG. 2, with the Vacutainer™ connector shown connected to the blood collection tube of the ESR measurement instrument, the needle of the connector being pierced through the rubber cap, and the blood collection tube partially filled with sample of whole blood;

FIG. 4E is a cross-sectional view of the ESR measurement instrument of the illustrative embodiment shown in FIG. 2, with the Vacutainer™ connector shown removed from the blood collection tube of the ESR measurement instrument, and the blood collection tube completely filled with sample of whole blood;

FIG. 5A is a perspective view of the air/fluid flow restriction plug inserted within the aperture formed in the top flange of sedimentation measurement tube, shown in FIG. 2;

FIG. 5B is a perspective view of the top flange of sedimentation measurement tube, with the air/fluid flow restriction plug removed from the top opening formed therein, shown in FIG. 2A;

FIGS. 6A and 6B are partially-broken away perspective views of the blood collection tube of the ESR measurement instrument of FIG. 2, showing the sedimentation measurement tube being rotated by 90 degrees, from its locked position to its unlocked position, thereby enabling the lock projections on the sedimentation measurement tube to pass through and along the lock grooves formed in the flange portion of the blood collection tube, and the rubber plunger to be plunged towards the bottom portion thereof while rearranging the ESR measurement instrument into its Blood Measurement Configuration;

FIG. 7A is a cross-sectional view of the ESR measurement instrument unlocked and ready for its blood sedimentation tube to be plunged into the bottom portion of the blood collection tube;

FIGS. 7B and 7C are cross-sectional views of the ESR measurement instrument showing its blood sedimentation tube being plunged towards the bottom portion of the blood collection tube to such an extent that the seal/membrane portion of the rubber plunger is about to be ruptured under pressure;

FIG. 7D is a cross-sectional view of the ESR measurement instrument showing its blood sedimentation tube being plunged towards the bottom portion of the blood collection tube to such an extent that the seal/membrane portion of the rubber plunger has ruptured under pressure and the blood sample in the blood collection tube has intermixed with the agent in the sedimentation measurement tube and blood has traveled up to a first position along the sedimentation tube;

FIG. 7E is a cross-sectional view of the ESR measurement instrument showing its blood sedimentation tube being plunged closer towards the bottom portion of the blood collection tube to such an extent that the seal/membrane portion of the rubber plunger has ruptured under pressure and the blood sample in the blood collection tube has intermixed with the agent in the sedimentation measurement tube and blood has traveled up to a second position along the sedimentation tube;

FIG. 7F is a cross-sectional view of the ESR measurement instrument showing its blood sedimentation tube being plunged to the bottom portion of the blood collection tube and blood has traveled up to a upper portion of the sedimentation measurement tube;

FIG. 8 is a perspective view of the ESR measurement instrument shown in FIG. 7F, and ready for ESR measurement after the standard 60 minute wait period, and ready for disposal within a medical recycling bin or like structure;

FIG. 9 is a perspective view of the ESR measurement instrument shown in FIG. 8, after ESR measurement has been made, and ready for disposal within a medical recycling bin or like structure;

FIG. 10 sets forth a flow chart illustrating the steps involved in a first illustrative embodiment of the method of ESR measurement according to the principles of the present invention carried out using the “prevacuated” embodiment of the ESR measurement instrument of the present invention; and

FIG. 11 sets forth a flow chart illustrating the steps involved in a second illustrative embodiment of the method of ESR measurement according to the principles of the present invention carried out using the “non-prevacuated” embodiment of the ESR measurement instrument of the present invention.

### DETAILED DESCRIPTION OF THE ILLUSTRATIVE EMBODIMENTS OF THE PRESENT INVENTION

The illustrative embodiment of the present invention will now be described in detail with reference to the accompanying Drawings, wherein like structures and elements shown throughout the figures thereof shall be indicated with like reference numerals.

The detailed description set forth below discloses a detailed specification of the embodiment of the ESR measurement instrument of the present invention. In general, this ESR measurement instrument is both portable and disposable in nature, and is designed for quickly performing precise ESR measurements in diverse environments including, for example, doctor offices, laboratories, hospitals, medical clinics, battlefields, and the like.

Illustrative Embodiment of the ESR Measurement Instrument of the Present Invention

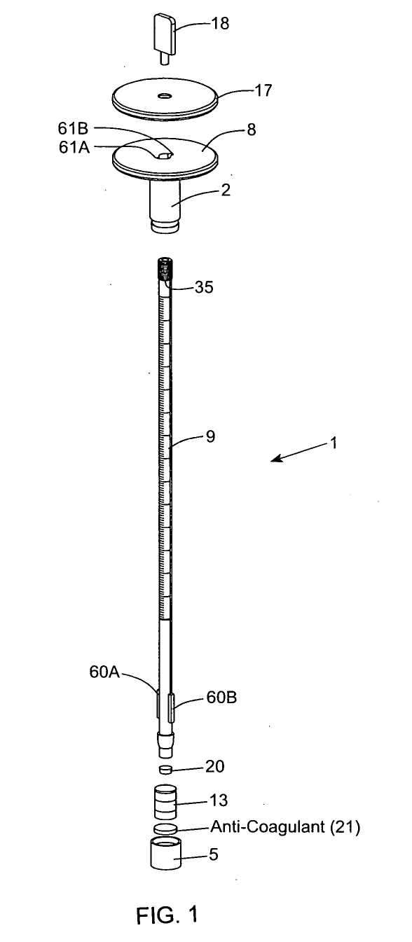

Referring now to FIGS. 1 through 9, a preferred illustrative embodiment of the portable and disposable ESR test measurement instrument of the present invention I will now be described in detail. This embodiment has several advantages over other designs described herein, including the ability for its blood collection tube to be vacuum-sealed (under a premeasured or preestimated vacuum) during assembly/manufacture, or alternatively, for air within the blood collection tube to be manually evacuated (under a premeasured vacuum) prior to blood drawing operations. Such features will be described in greater detail below.

In FIG. 1, the components of the ESR measurement instrument of the illustrative embodiment are shown disassembled, but aligned for assembly. The ESR measurement instrument 1 can be assembled as follows: the proximal end of the sedimentation tube 9 is first passed through the blood collection tube 2 with the lock flanges (i.e. projections) 30A and 30B passed through and along corresponding lock grooves (i.e. channels) 31A and 31B formed in the top portion of the blood collection tube and its associated annular flange 8; the proximal end of the sedimentation tube 9″ is then screwed to annular flange 17; then the air/fluid restriction plug 18 is inserted within the top opening of the sedimentation tube; the rubber plunger 13 is filled with a small quantity of anti-coagulant (e.g. EDTA or citrate) 20; the rubber plunger element 13 is snap-fit attached over the surface projection formed at the end of the sedimentation measurement tube 9; the rubber cap 5 is then filled with pre-measured quantity of anti-coagulant 21; and then the rubber cap 5 is then attached to the distal end of the blood collection tube 2, preferably under a vacuum conditions, so as to provide a pre-measured, predetermined or pre-estimated vacuum within the blood collection tube during the assembly of the ESR measurement instrument. An air-permeable, blood-impermeable material is inserted within the first inch or so of the hollow interior volume of the sedimentation measurement tube, just about a half inch from the top opening. Clearly, there are alternative methods and orders for assembling the components of the ESR measurement instrument of the illustrative embodiment, described above.

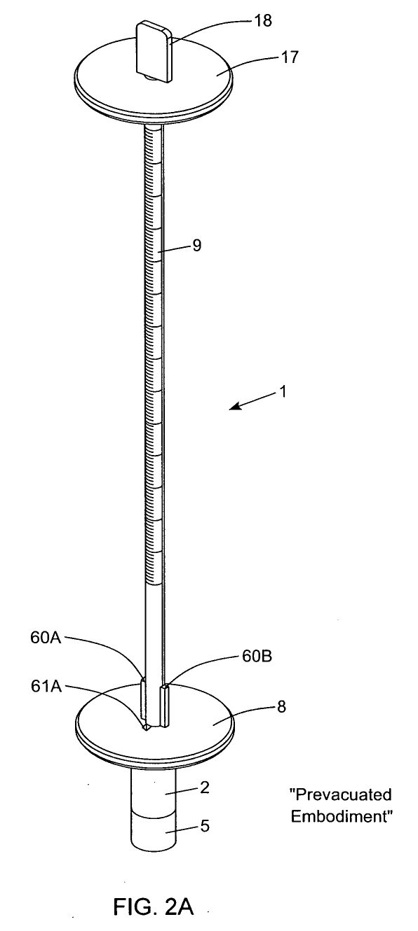

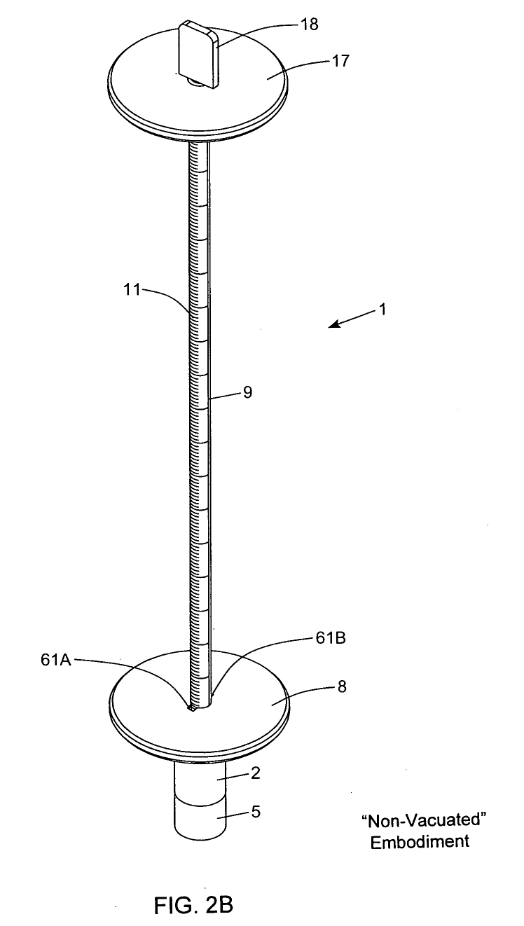

As shown in FIG. 2, the “prevacuated” embodiment of the ESR measurement instrument of the illustrative embodiment is arranged and manufactured so that the interior of the blood collection tube has a pre-measured vacuum (i.e. its interior volume is vacuum sealed) for automatically withdrawing a predetermined sample of human blood during blood collection operations.

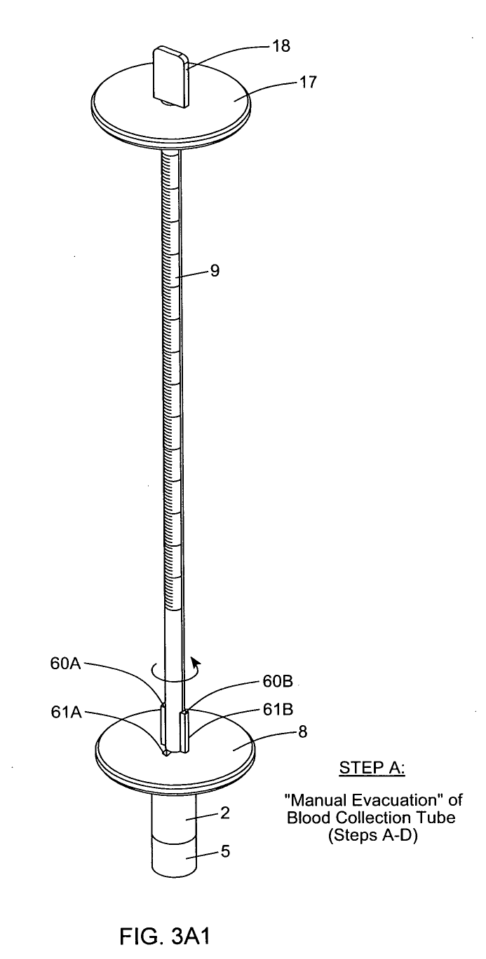

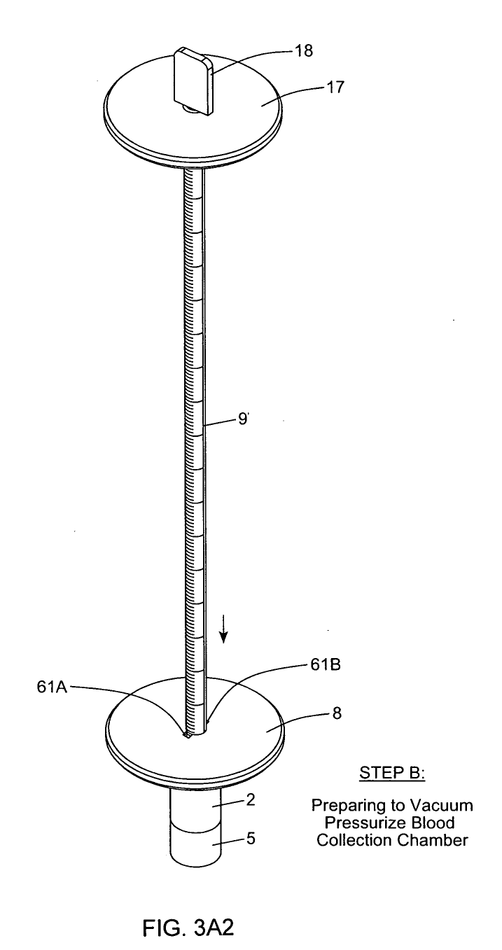

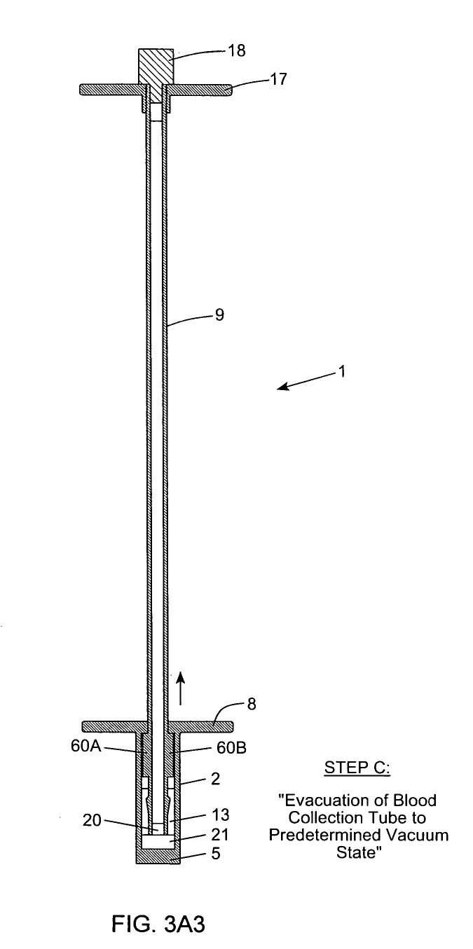

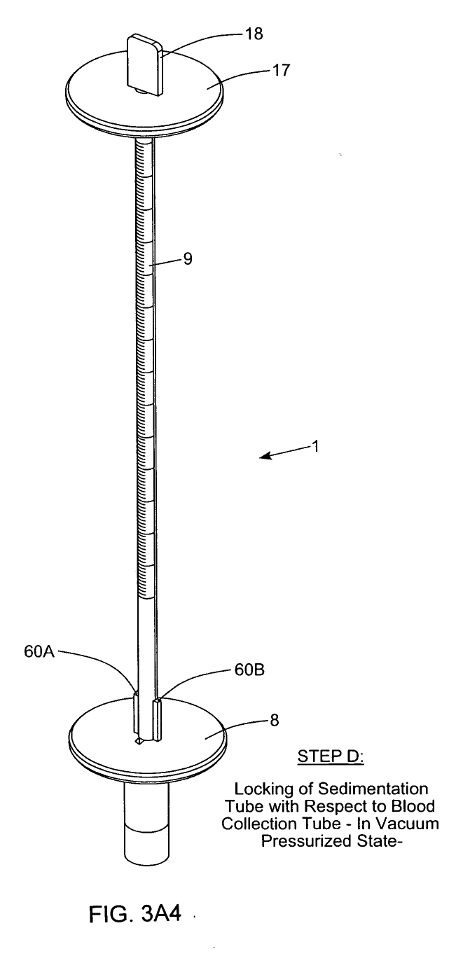

Alternatively, as shown in FIG. 3A1, a “non-prevacuated” embodiment of the ESR measurement instrument of the present invention can be assembled at the time of manufacture with the sedimentation and blood collection tubes located relative each other as shown in FIG. 3A1, and without any premeasured vacuum created within the interior of the blood collection tube. Then, the instrument can be packaged in a conventional manner. At the site where blood is to be drawn from a patient, the technician or doctor can remove the instrument from its packaging, and withdraw the sedimentation measurement tube 9″ out from the blood collection tube 2 (with the lock projections 30A and 30B aligned with the lock slots 31A and 31B), and then turn the sedimentation tube 9 by 90 degrees to lock the same relative to the blood collection tube 2, as shown. By doing so, a pre-measured vacuum can be created within the interior volume of the blood collection tube, sufficient to withdraw a full sample of blood from a patient during subsequent blood collection operations. In view of the present disclosure, there are alternative methods of packaging the ESR measurement instrument in particular configurations, and providing instructions on how to manually pre-evacuate the blood collection tube for the vacuum-driven withdrawal of a human blood sample to be collected and tested within the ESR measurement instrument of the present invention

First Illustrative Method of ESR Measurement in Accordance with Principles of Present Invention

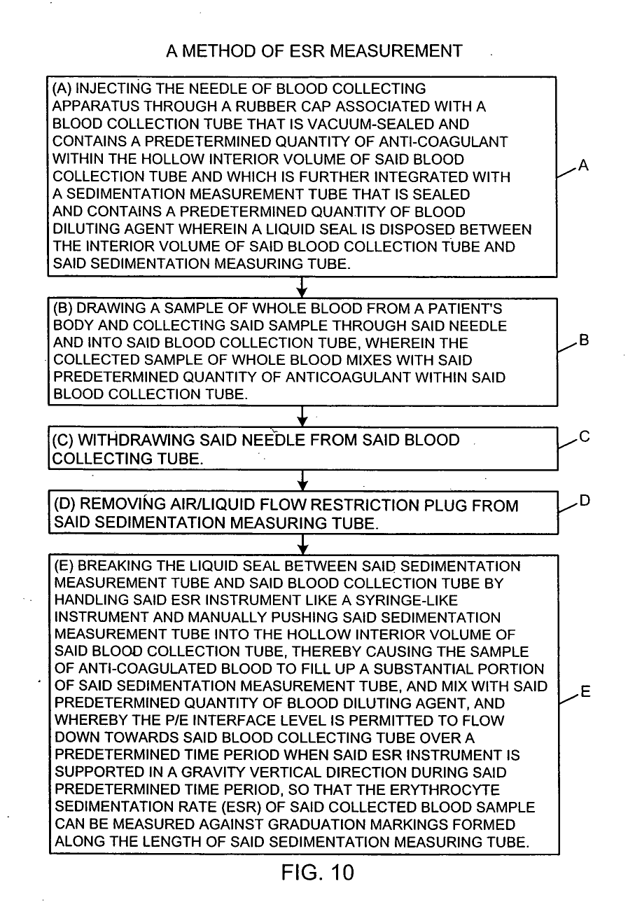

Referring to Blocks A through E in FIG. 10, the steps involved in carrying out the first method of ESR measurement according to the present invention will now be described in detail using the ESR test measurement instrument of the “prevacuated” illustrative embodiment, shown in FIG. 2A and described above.

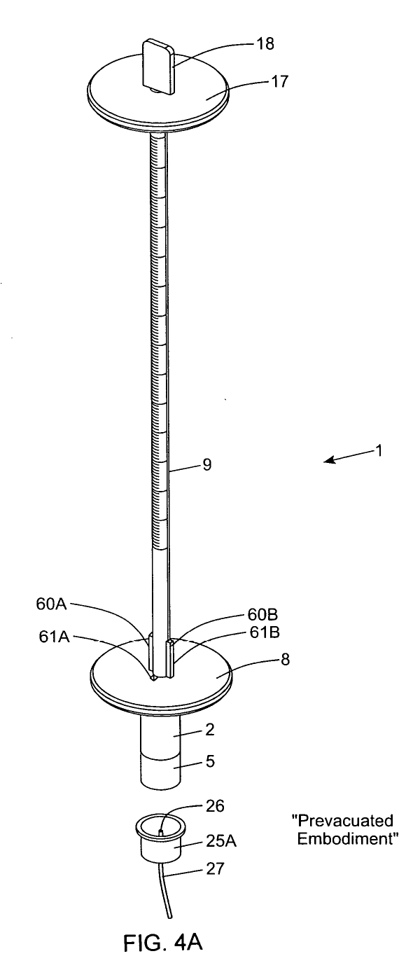

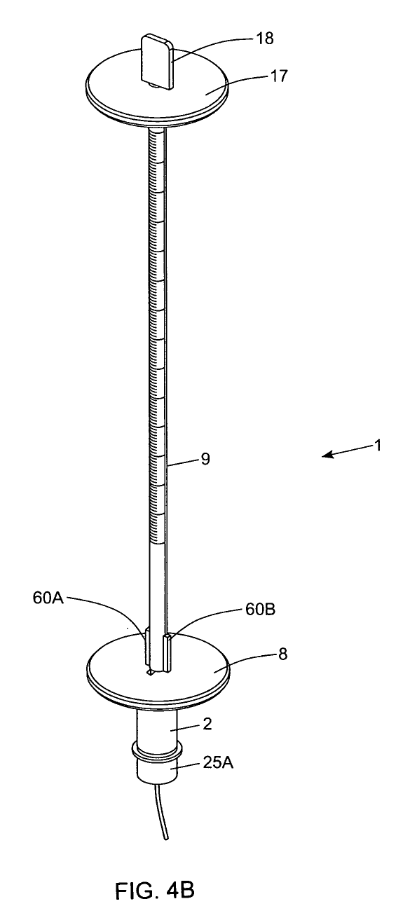

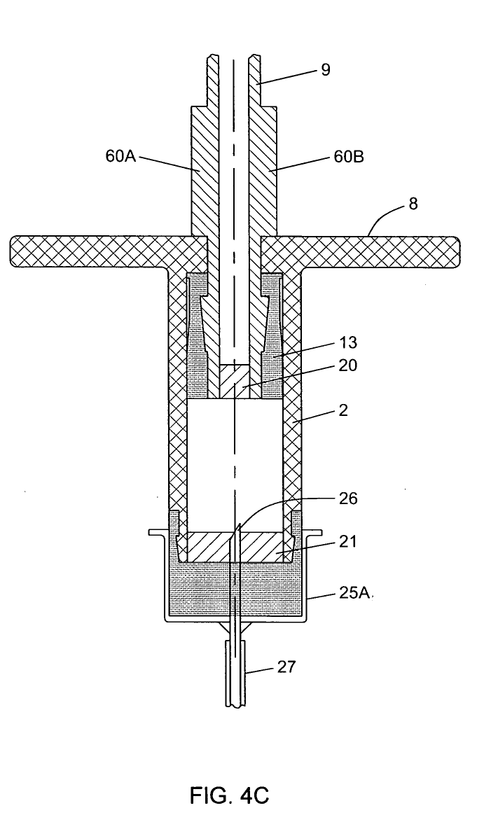

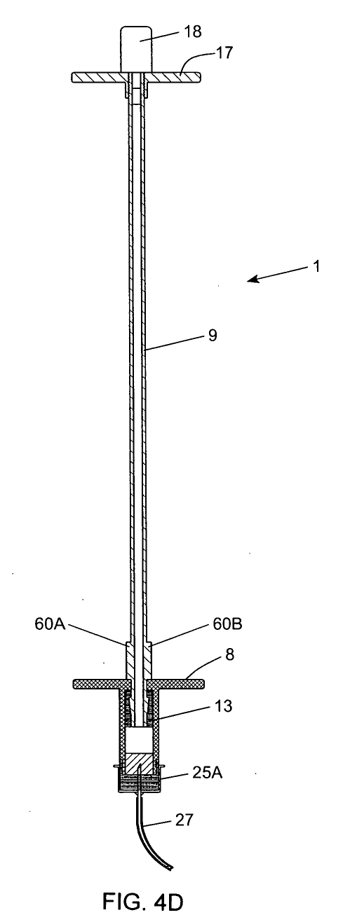

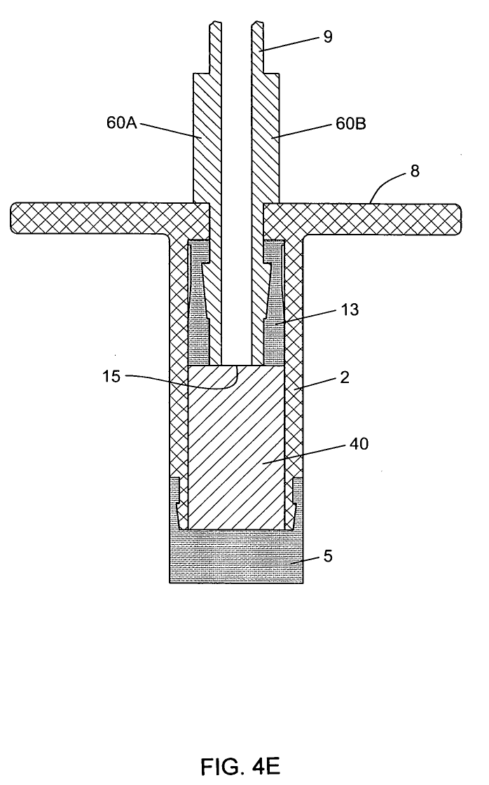

As indicated at Block A of FIG. 10, the first step of the ESR measurement method involves injecting needle of a Leur® lock type blood collecting apparatus 25A through the rubber cap 5 of the blood collection tube, as shown in FIG. 4A. This connection apparatus occurs with the tube holder and restraint assembly maintained installed about the sedimentation measurement and blood collection tubes, and the air/fluid flow restriction plug 18 remains inserted within the top opening of the sedimentation measurement tube 9. The blood collection apparatus employed during this step of the method typically will include a section of flexible tubing 27 that is connected to a Leur® lock connector on one end, and terminates in a hypodermic needle on the other end. The hypodermic needle should be suitable for safely drawing blood from a human subject. One or more medical connectors may be inserted in-line between the blood collection tube and the hypodermic needle, in a manner well known in the art. Once the hypodermic needle punctures the skin of the human subject, the vacuum pressure within the blood collection tube 2 automatically draws a predetermined sample of whole human blood 40, which flows through the tubing 27 and fills up the blood collection container 2.

As indicated at Block B in FIG. 10, during this blood drawing operation, blood 40 entering the blood collection tube 2 mixes with the quantity of anti-coagulant in the blood collection tube to prevent coagulation of the blood sample within the blood collection tube, as shown in FIG. 4D.

As indicated at Block C in FIG. 10, as the blood collection tube is filled to its predetermined volume (e.g. 1 ml) by the vacuum created at the time of instrument assembly, as shown in FIGS. 4D and 4E, whole blood from the human subject will stop flowing into the blood collection measurement tube 2, and the needle 28 can be then removed from the human subject and the Leur® lock connector 25A can be withdrawn and removed from the blood collection tube 2.

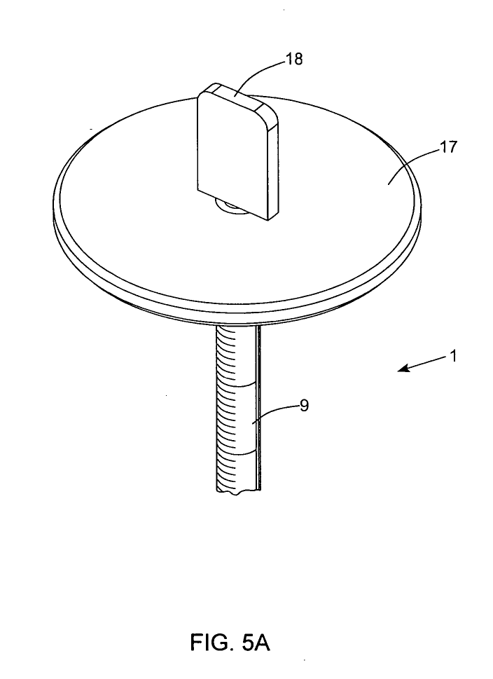

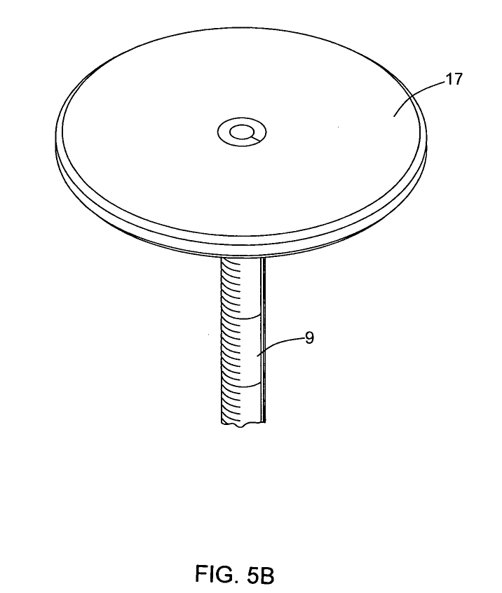

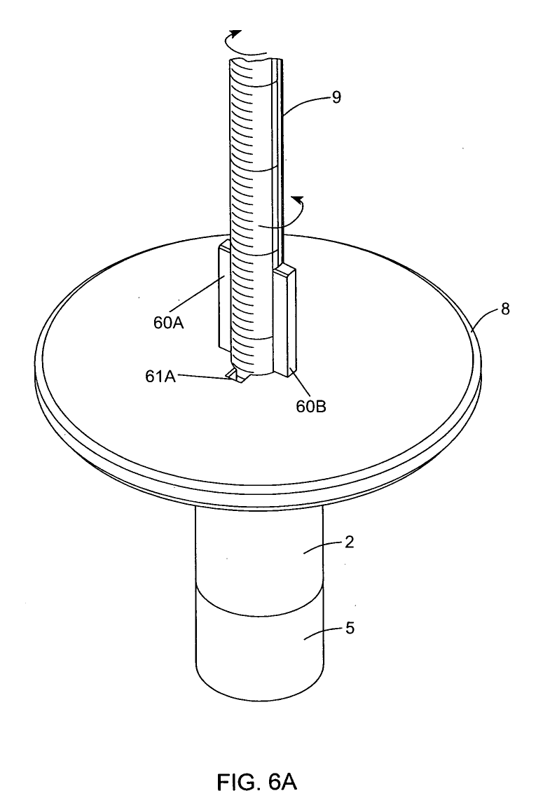

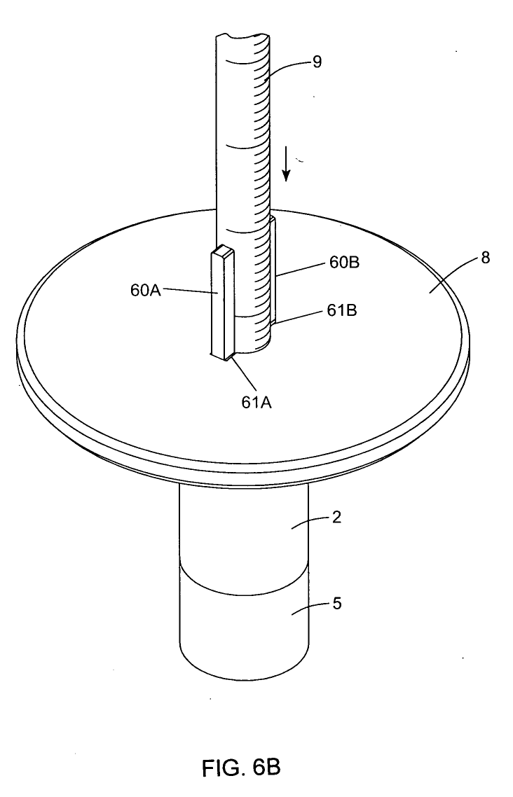

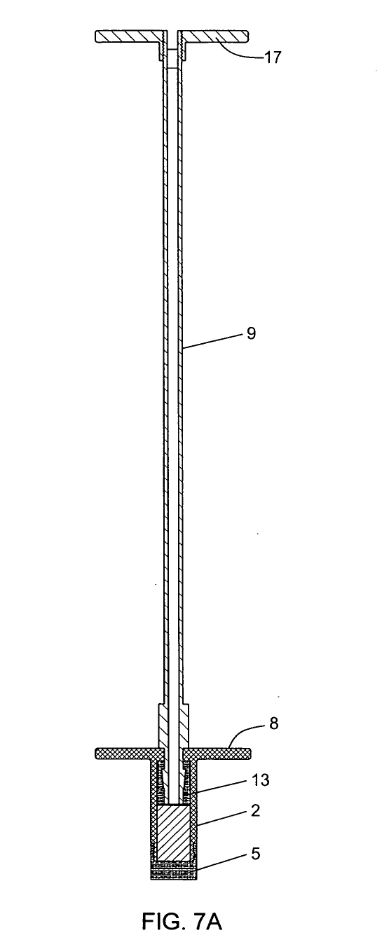

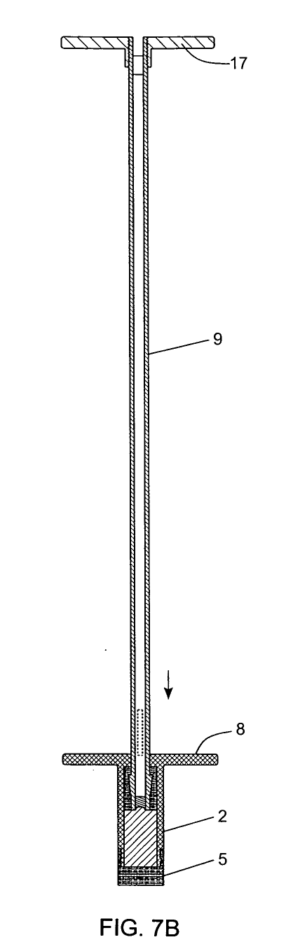

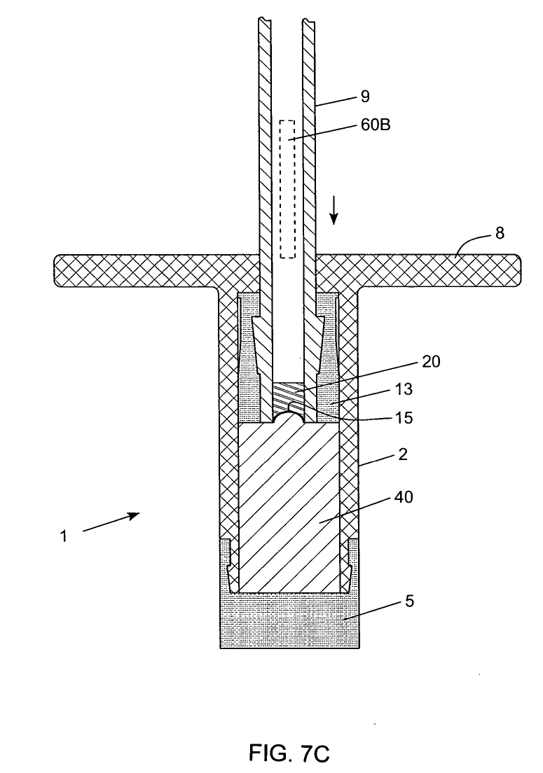

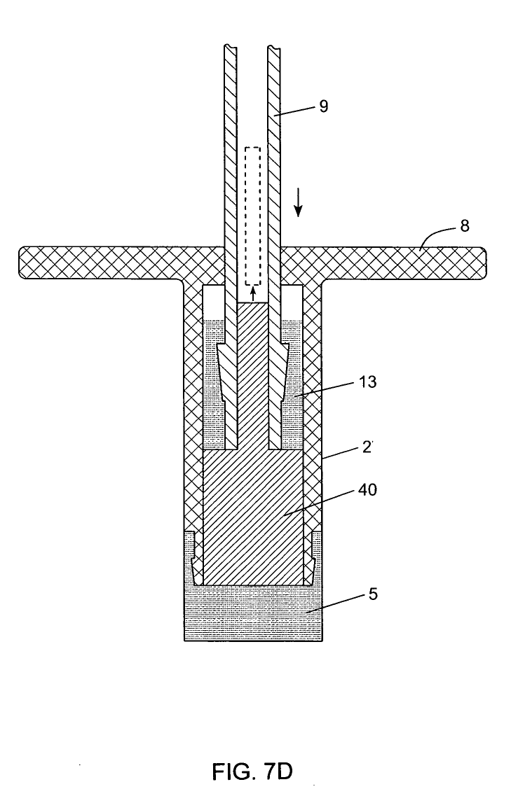

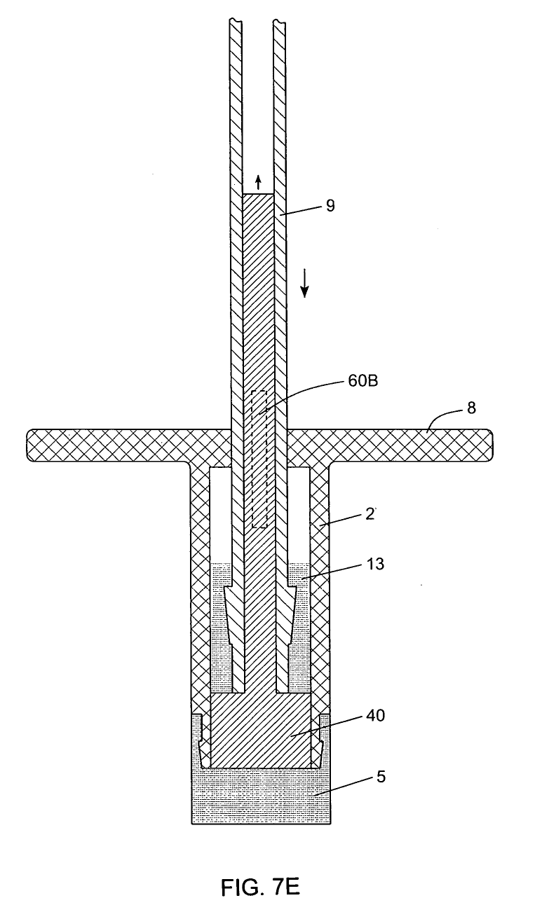

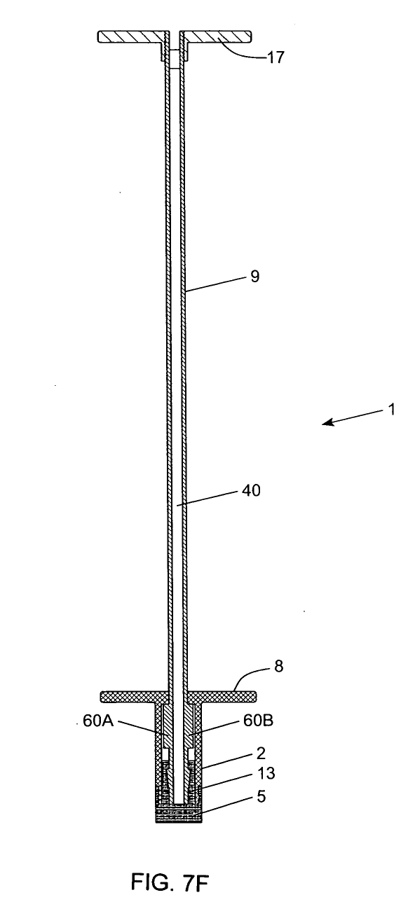

As indicated at Block D of FIG. 10, the next step of the ESR measurement method involves removing the air/fluid restriction plug 18 from the top of the sedimentation measurement tube, as shown in FIGS. 5A and 5B. Upon removal of the air/fluid flow restriction plug 18, ambient air is permitted to flow within the interior volume 10 of the sedimentation measurement tube 9 so that pressure therewithin can be equalized with the air pressure of the ambient environment. Then the sedimentation and blood collection tubes are unlocked relative to each under (to enable plunging action), by rotating the lock projections 60A and 60B by an angular amount of 90 degrees, as shown in FIGS. 6A and 6B, so that the lock projections 60A and 60B aligned (i.e. register) with the lock slots 61A and 61B, respectively, formed in the flange of the blood collection tube. In this aligned (i.e. registered) configuration, with the flow restriction plug 18 removed, as shown in FIG. 6B, the sedimentation measurement tube 9 can be plunged into the blood collection tube as shown in FIGS. 7A through 7F, so as to rupture the membrane 15 at the bottom of the rubber plunger 13 and force blood within the blood collection tube into the sedimentation measurement tube, in essentially the same way described in the other disclosed embodiments of the present invention. In the state shown in FIG. 7F, the collected blood sample is ready for ESR measurement testing as described hereinabove.

As indicated at Block E in FIG. 10, the ESR measurement method involves the user (e.g. tester or clinician) manually grasping the ESR measurement instrument with the lower flange 8 positioned between the user's index and middle fingers, and the user's thumb positioned on the top (i.e. upper) flange 17 as when handling a conventional syringe. In this instrument handling arrangement, the user pushes the sedimentation measurement tube 9 down into the blood collection tube 2 using his or her thumb, just as when expressing liquid from a conventional syringe. This downward action of sedimentation tube 9 into the blood collection tube 2 causes the rupturable membrane 15 to rupture, and forces the sample of anti-coagulated blood 40 in the blood collection tube 2 to rush up into the hollow interior volume of the sedimentation measurement tube 9, and mix with the blood diluting agent (e.g. physiologic NaCl solution or sodium citrate solution) contained therein. The process of the membrane 15 rupturing in response to the rubber plunger 13 being plunged into the blood collection tube 2 is schematically illustrated in FIG. 7A through 7D. As shown, during this process, the membrane 15 stretches as the hydrostatic pressure beneath its surface increases with increasing downward pressure, up until a point where the membrane material fails and ruptures, without compromising the overall structural integrity of the side wall portions of the rubber plunger component. As the sedimentation measurement tube 9 is plunged into the blood collection tube, the pressure of the blood sample therein increases, causing the anti-coagulated blood sample to flow through the ruptured membrane 15 and up along the hollow interior volume of the sedimentation measurement tube, as shown in FIG. 7D through 7F. At the same time, the rubber walls of the plunger 15 and gasket 19 create a high-quality liquid seal that prevents no amount of the collected blood sample to leak out from the combined contained volume created by the hollow interior volume of the sedimentation measurement tube being arranged in fluid communication with the hollow interior volume of the blood collection tube. Also, preferably, an air-permeable, blood-impermeable material will be inserted (at the time of assembly) within the first inch or so of the hollow interior volume of the sedimentation measurement tube, just about a half inch from the top opening, so that blood, when forced up along and occupying the hollow interior volume 10 during the ESR Measurement Configuration, cannot leak out of the sedimentation measurement tube portion of the ESR measurement instrument.

In this final state of configuration, the whole anti-coagulated blood sample contained in the ESR measurement instrument is thoroughly mixed with the blood diluting agent (e.g. physiologic NaCl solution or sodium citrate solution) 20, and the blood plasma/erythrocyte cell (P/E) interface level begins to settle within the vertically-supported sedimentation measurement tube under the influence of gravitational forces. At the same time, the diluted anti-coagulated whole blood sample is safely sealed (i.e. entombed) within locked instrument.

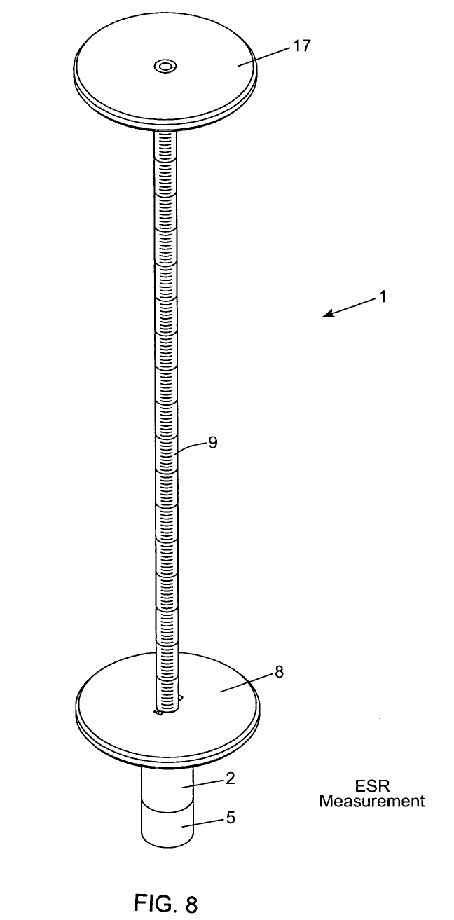

As shown in FIG. 8, to perform ESR measurement in accordance with the Westergren or like method, the ESR measurement instrument is positioned upright, for example, inserted in a perfectly vertical support stand having a support aperture and bubble-level (e.g., located on a table, lab bench, or other stable surface) for a time period of about 60 minutes. At the end of this time period, an accurate ESR measurement ready can be read by measuring how far the plasma/erythrocyte (P/E) interface level has settled in millimeters under the influence of gravity after sixty minutes, i.e. measured in [mm/hr] against the calibrated graduations 11 formed along the length of the sedimentation measurement tube.

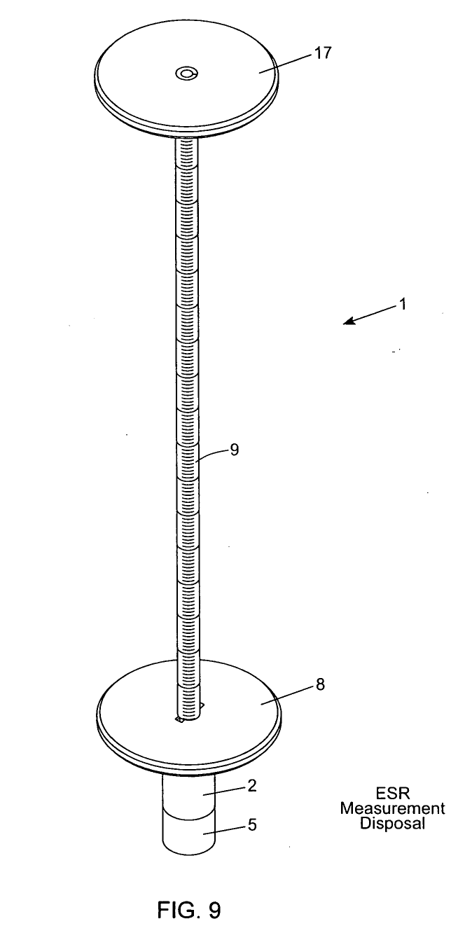

After the ESR measurement is taken (i.e. by reading the P/E interface level location) against the calibrated graduations 11 along the sedimentation measurement tube, and recorded in the patient's medical record, the ESR measurement instrument can be safely discarded as medical waste according to government regulations and/or safety standards, as shown in FIG. 9, without risk of blood spillage or leakage by the inherent design of the instrument. Preferably, the air/fluid restriction plug 18 is reinserted within the top of the sedimentation measurement tube, although this is not required for safely disposing the ESR instrument within a blood collection container well known in the medical art.

As the collected blood sample is always contained within the instrument during the ESR measurement method of the present invention, this is little if any risk to the technician performing the ESR measurement using the ESR measurement instrument of the present invention. Also, as the instrument is essentially a locked, sealed device, the risk of leakage or environmental contamination is substantially minimized.

Second Illustrative Method of ESR Measurement in Accordance with Principles of Present Invention

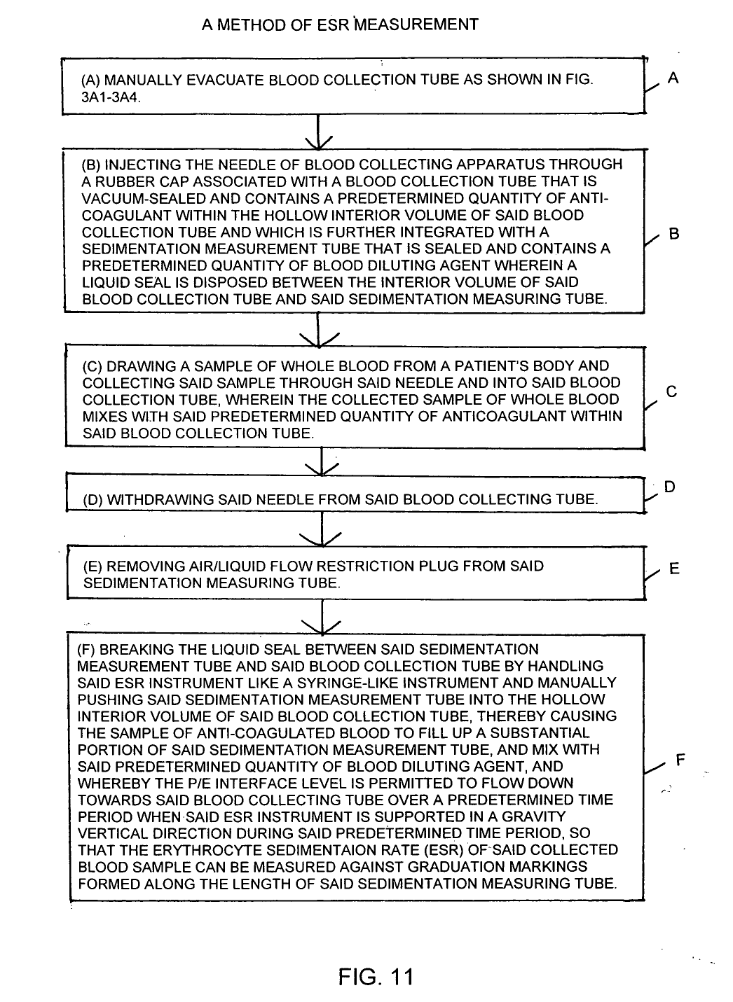

Referring to Blocks A through F in FIG. 11, the steps involved in carrying out the second method of ESR measurement according to the present invention will now be described in detail using the ESR test measurement instrument of the “non-prevacuated” illustrative embodiment, shown in FIG. 2B and described above.

As indicated at Block A of FIG. 11, the first step of the ESR measurement method involves the technician or doctor remove the instrument from its packaging, and withdraw the sedimentation measurement tube 9″ out from the blood collection tube 2 (with the lock projections 30A and 30B aligned with the lock slots 31A and 31B), and then turn the sedimentation tube 9 by 90 degrees to lock the same relative to the blood collection tube 2, as shown FIGS. 3A1 through 3A4.

As indicated at Block B of FIG. 11, the second step of the ESR measurement method involves injecting needle of a Leur® lock type blood collecting apparatus 25A through the rubber cap 5 of the blood collection tube, as shown in FIG. 4A. This connection apparatus occurs with the tube holder and restraint assembly maintained installed about the sedimentation measurement and blood collection tubes, and the air/fluid flow restriction plug 18 remains inserted within the top opening of the sedimentation measurement tube 9. The blood collection apparatus employed during this step of the method typically will include a section of flexible tubing 27 that is connected to a Leur® lock connector on one end, and terminates in a hypodermic needle on the other end. The hypodermic needle should be suitable for safely drawing blood from a human subject. One or more medical connectors may be inserted in-line between the blood collection tube and the hypodermic needle, in a manner well known in the art. Once the hypodermic needle punctures the skin of the human subject, the vacuum pressure within the blood collection tube 2 automatically draws a predetermined sample of whole human blood 40, which flows through the tubing 27 and fills up the blood collection container 2.

As indicated at Block C in FIG. 11, during this blood drawing operation, blood 40 entering the blood collection tube 2 mixes with the quantity of anti-coagulant in the blood collection tube to prevent coagulation of the blood sample within the blood collection tube, as shown in FIG. 4D.

As indicated at Block D in FIG. 11, as the blood collection tube is filled to its predetermined volume (e.g. 1 ml) by the vacuum created at the time of instrument assembly, as shown in FIGS. 4D and 4E, whole blood from the human subject will stop flowing into the blood collection measurement tube 2, and the needle 28 can be then removed from the human subject and the Leur® lock connector 25A can be withdrawn and removed from the blood collection tube 2.

As indicated at Block E of FIG. 11, the next step of the ESR measurement method involves removing the air/fluid restriction plug 18 from the top of the sedimentation measurement tube, as shown in FIGS. 5A and 5B. Upon removal of the air/fluid flow restriction plug 18, ambient air is permitted to flow within the interior volume 10 of the sedimentation measurement tube 9 so that pressure therewithin can be equalized with the air pressure of the ambient environment. Then the sedimentation and blood collection tubes are unlocked relative to each under (to enable plunging action), by rotating the lock projections 60A and 60B by an angular amount of 90 degrees, as shown in FIGS. 6A and 6B, so that the lock projections 60A and 60B aligned (i.e. register) with the lock slots 61A and 61B, respectively, formed in the flange of the blood collection tube. In this aligned (i.e. registered) configuration, with the flow restriction plug 18 removed, as shown in FIG. 6B, the sedimentation measurement tube 9 can be plunged into the blood collection tube as shown in FIGS. 7A through 7F, so as to rupture the membrane 15 at the bottom of the rubber plunger 13 and force blood within the blood collection tube into the sedimentation measurement tube, in essentially the same way described in the other disclosed embodiments of the present invention. In the state shown in FIG. 7F, the collected blood sample is ready for ESR measurement testing as described hereinabove.

As indicated at Block F in FIG. 11, the ESR measurement method involves the user (e.g. tester or clinician) manually grasping the ESR measurement instrument with the lower flange 8 positioned between the user's index and middle fingers, and the user's thumb positioned on the top (i.e. upper) flange 17 as when handling a conventional syringe. In this instrument handling arrangement, the user pushes the sedimentation measurement tube 9 down into the blood collection tube 2 using his or her thumb, just as when expressing liquid from a conventional syringe. This downward action of sedimentation tube 9 into the blood collection tube 2 causes the rupturable membrane 15 to rupture, and forces the sample of anti-coagulated blood 40 in the blood collection tube 2 to rush up into the hollow interior volume of the sedimentation measurement tube 9, and mix with the blood diluting agent (e.g. physiologic NaCl solution or sodium citrate solution) contained therein. The process of the membrane 15 rupturing in response to the rubber plunger 13 being plunged into the blood collection tube 2 is schematically illustrated in FIG. 7A through 7D. As shown, during this process, the membrane 15 stretches as the hydrostatic pressure beneath its surface increases with increasing downward pressure, up until a point where the membrane material fails and ruptures, without compromising the overall structural integrity of the side wall portions of the rubber plunger component. As the sedimentation measurement tube 9 is plunged into the blood collection tube, the pressure of the blood sample therein increases, causing the anti-coagulated blood sample to flow through the ruptured membrane 15 and up along the hollow interior volume of the sedimentation measurement tube, as shown in FIG. 7D through 7F. At the same time, the rubber walls of the plunger 15 and gasket 19 create a high-quality liquid seal that prevents no amount of the collected blood sample to leak out from the combined contained volume created by the hollow interior volume of the sedimentation measurement tube being arranged in fluid communication with the hollow interior volume of the blood collection tube. Also, preferably, an air-permeable, blood-impermeable material will be inserted (at the time of assembly) within the first inch or so of the hollow interior volume of the sedimentation measurement tube, just about a half inch from the top opening, so that blood, when forced up along and occupying the hollow interior volume 10 during the ESR Measurement Configuration, cannot leak out of the sedimentation measurement tube portion of the ESR measurement instrument.

In this final state of configuration, the whole anti-coagulated blood sample contained in the ESR measurement instrument is thoroughly mixed with the blood diluting agent (e.g. physiologic NaCl solution or sodium citrate solution) 20, and the blood plasma/erythrocyte cell (P/E) interface level begins to settle within the vertically-supported sedimentation measurement tube under the influence of gravitational forces. At the same time, the diluted anti-coagulated whole blood sample is safely sealed (i.e. entombed) within locked instrument.

As shown in FIG. 8, to perform ESR measurement in accordance with the Westergren or like method, the ESR measurement instrument is positioned upright, for example, inserted in a perfectly vertical support stand having a support aperture and bubble-level (e.g., located on a table, lab bench, or other stable surface) for a time period of about 60 minutes. At the end of this time period, an accurate ESR measurement ready can be read by measuring how far the plasma/erythrocyte (P/E) interface level has settled in millimeters under the influence of gravity after sixty minutes, i.e. measured in [mm/hr] against the calibrated graduations 11 formed along the length of the sedimentation measurement tube.

After the ESR measurement is taken (i.e. by reading the P/E interface level location) against the calibrated graduations 11 along the sedimentation measurement tube, and recorded in the patient's medical record, the ESR measurement instrument can be safely discarded as medical waste according to government regulations and/or safety standards, as shown in FIG. 9, without risk of blood spillage or leakage by the inherent design of the instrument. Preferably, the air/fluid restriction plug 18 is reinserted within the top of the sedimentation measurement tube, although this is not required for safely disposing the ESR instrument within a blood collection container well known in the medical art.

As the collected blood sample is always contained within the instrument during the ESR measurement method of the present invention, this is little if any risk to the technician performing the ESR measurement using the ESR measurement instrument of the present invention. Also, as the instrument is essentially a locked, sealed device, the risk of leakage or environmental contamination is substantially minimized.

Instrument Design and Implementation Considerations

When designing and implementing any of the illustrative embodiments of the ESR test measurement instrument of the present invention described above, it is understood that the actual physical dimensions of the blood collection tube and the sedimentation measurement tube will depend on several factors, including: (1) the actual amount of the whole blood sample to be collected and treated by the instrument during ESR testing; and (2) the particular type and variation of the ESR testing method (e.g. Westergren, Wintrobe, etc.) to be carried out using the ESR measurement instrument.

In applications where large whole blood samples can be collected (e.g. as with adult patients), the blood collection tube can be designed to contain a standard volume (e.g. 1.0 ml) of collected whole blood and a negligible amount of K3EDTA anti-coagulating agent, whereas the sedimentation measurement tube can be designed to contain this same amount of anti-coagulated blood in addition to a blood diluting agent (e.g. physiologic NaCl solution or sodium citrate solution) mixed in the standard ratio of 1 part blood dilutent to 4 parts of anti-coagulated blood. Preferably, the final form factor of the disposable ESR test measurement instrument design will resemble a slightly-elongated syringe-like instrument. The final ESR measurement instrument design should be calibrated against the standard Westergren ESR test method and apparatus kit, as published by NCCLS, in the document entitled “Reference and Selected Procedure For The Erythrocyte Sedimentation Rate (ESR) Test; Approved Standard—Fourth Edition”, (NCCLA Publication No. H2-A4), supra.

In applications where only small whole blood samples can be collected (e.g. as with infants and younger children), the blood collection tube can be designed to contain a smaller volume (e.g. 0.5 ml) of collected whole blood and a negligible amount of K3EDTA anti-coagulating agent, whereas the sedimentation measurement tube can be designed to contain this same amount of anti-coagulated blood in addition to a blood diluting agent (e.g. physiologic NaCl solution or sodium citrate solution) mixed in the standard ratio of 1 part blood dilutent to 4 parts of anti-coagulated blood. Preferably, the final form factor of the disposable ESR measurement instrument design will resemble a slightly-elongated syringe instrument. The final ESR measurement instrument design should be calibrated against the standard Westergren ESR test method and apparatus kit, as published in “Reference and Selected Procedure For The Erythrocyte Sedimentation Rate (ESR) Test; Approved Standard—Fourth Edition”, supra, so that test results from the ESR test measurement instrument of the present invention are strong correlated with test results obtained from the standard Westergren ESR test method.

Modifications which Come to Mind

While each embodiment of the disposable ESR test measurement instrument disclosed hereinabove has employed a rubber plunger element having a rupturable membrane, it is understood that in other embodiments of the present invention, the rupturable membrane may be realized using a blow-out type of plug or element which, in response to sufficient blood sample pressure, blows out permitting the blood sample to fill up the sedimentation measurement tube as the instrument is arranged in its ESR Measurement Configuration. Preferably, this blow-out type plug or element is hingedly connected to the walls of the rubber plunger so as to not interfere with the ESR test measurement. Clearly, other ways and means can be used to create this pressure-sensitive blood flow valve structure arranged between the hollow interior volume of the sedimentation measurement tube and the hollow interior volume of the blood collection tube of the instrument, in accordance with the general spirit of the present invention.

It is understood that the ESR instruments of the illustrative embodiments may be modified in a variety of ways which will become readily apparent to those skilled in the art, and having the benefit of the novel teachings disclosed herein. All such modifications and variations of the illustrative embodiments thereof shall be deemed to be within the scope and spirit of the present invention as defined by the accompanying Claims to Invention.

1: A blood test measurement instrument for performing a blood test, said measurement instrument having a blood collection configuration and an blood test measurement configuration, and comprising:
a blood test measurement tube having an hollow interior volume; and
a blood collection tube having a hollow interior volume containing a predetermined quantity of anti-coagulant and physically coupled to said blood test measurement tube, by at least a portion of said blood test measurement tube being inserted within a portion of the hollow interior volume of said blood collection tube; and
a liquid seal disposed between the hollow interior volume of said blood collection tube and the hollow interior volume of said blood test measurement tube when said blood test measurement instrument is arranged in said blood collection configuration;
a locking mechanism integrated with sedimentation tube and said blood collection tube that prevents said sedimentation tube from being plunged into said blood collection container until the user rotates said tubes by predetermined amount;
wherein said blood test measurement tube and said blood collection tube are maintained fixed relative to each other as a unitary assembly when said measurement instrument is arranged in said blood collection configuration, during which a needle-supporting connector can be connected to said blood collection tube and a sample of whole blood from a patient is drawn and injected into said blood collection tube; and
wherein after the sample of anti-coagulated blood has been collected in said blood collection tube and the needle-supporting connector is disconnected therefrom, said blood test measurement tube can be manually plunged into and to the bottom of the hollow interior volume of said blood collection tube, so as to rearrange said measurement instrument into said blood test measurement configuration, whereby the anti-coagulated sample of blood fills up a substantially portion of said blood test measurement tube, within which a blood test is subsequently performed.

2: The blood test measurement instrument of claim 1, wherein said blood test is an erythrocyte sedimentation rate (ESR) test and wherein said blood test measurement tube is a sedimentation measurement tube having graduation markings formed along the length thereof, and wherein when said fluid seal of said blood test measurement tube is broken and said blood measurement tube is manually plunged into and to the bottom of the hollow interior volume of said blood collection tube, said measurement instrument is rearranged into said blood test measurement configuration, whereby the anti-coagulated sample of blood fills up a substantially portion of said sedimentation measurement tube and mixes with a blood sample diluting agent to enable the blood plasma/erythrocyte cell (P/E) interface level within said sedimentation measurement tube to settle downwards toward said blood collection tube during a predetermined time period when said measurement instrument is oriented in a gravity vertical position, so that the erythrocyte sedimentation rate (ESR) of said collected blood sample can be measured by determining how far said P/E interface level has moved against graduation markings formed along the length of said sedimentation measurement tube during said predetermined time period.

3: The blood test measurement instrument of claim 2, wherein said sedimentation measurement tube contains a predetermined quantity of blood sample diluting agent with said hollow interior volume, and is air/fluid sealed with respect to the ambient environment.

4: The blood test measurement instrument of claim 2, wherein said blood collection tube further contains a predetermined quantity of blood sample diluting agent within its hollow interior volume, and said sedimentation measurement tube is air/fluid sealed with respect to the ambient environment.

5-44. (canceled)
